(19) United States
(12) Patent Application Publication
(10) Pub. No.: US 2016/0353390 A1
(43) Pub. Date: Dec. 1, 2016

(54) DEVICE AND METHOD FOR CONTROLLING TRANSMITTING POWER OF NETWORK ACCESS APPARATUS

(71) Applicants: LE HOLDINGS (BEIJING) CO., LTD., Beijing (CN); Lemobile Information Technology (Beijing) Co., Ltd, Beijing (CN)

(72) Inventor: Binjian ZHANG, Beijing (CN)

(21) Appl. No.: 15/232,763

(22) Filed: Aug. 9, 2016

Related U.S. Application Data
(63) Continuation of application No. PCT/CN2015/084220, filed on Jul. 16, 2015.

(30) Foreign Application Priority Data
Aug. 27, 2014 (CN) 201410429294.X

(51) Int. Cl. H04W 52/18

(52) U.S. Cl. CPC H04W 52/18

(57) ABSTRACT

Disclosed is a device for controlling transmitting power of network access apparatus, which is applicable to a portable terminal or the network access apparatus and which obtains strength of wireless signal sent from the network access apparatus and received by the portable terminal, according to the wireless network connection. The disclosure can calculate out a minimum transmitting power of the network access apparatus which allows the portable terminal to receive wireless signal sent from the network access apparatus by the strength of wireless signal, and then control the transmitting power of the network access apparatus according to the minimum transmitting power. Therefore, the disclosure can reduce the wireless radiation of the network access apparatus without impacting on the network connection. Further, operations of the disclosure are very simple without interference with daily use.

### CROSS-REFERENCE TO RELATED APPLICATIONS

The present disclosure is a continuation of International Application PCT/CN2015/084220 filed on Jul. 16, 2015, which is based upon and claims priority to Chinese Patent Application No. CN201410429294.X, entitled “DEVICE AND METHOD FOR CONTROLLING TRANSMITTING POWER OF NETWORK ACCESS APPARATUS”, filed on Aug. 27, 2014, the entire contents of all of which are incorporated herein by reference.

### TECHNICAL FIELD

The present disclosure relates to the field of control technologies of transmitting power, and in particular to a device and method for controlling transmitting power of network access apparatus.

### BACKGROUND

With the development of network technologies, WLAN (Wireless Local Area Networks) has become a more convenient data transmission system by using RF (Radio Frequency) technology, in place of LAN established by old twisted copper wires (Coaxial). Generally, the WLAN is connected to Internet by a network access apparatus or called as gateway equipment, particularly such as Wireless Router, etc. As portable devices such as cell phone, tablet and the like emerge in large numbers, now a family is inclined to establish a WLAN by a network access apparatus such as wireless router, so as to fulfill increasing wireless network access requirements in people's daily life.

However, except for the consumption of electrical energy, the network access apparatus such as wireless router may also generate wireless radiation. In order to eliminate the influence of the wireless radiation, some families may directly switch off a power supply of the network access apparatus such as wireless router in the case of no need for wireless network connection, or switch off a RF transmitter module through Web UI thereof. When there is a need for wireless network connection, they may switch on the power supply of the network access apparatus such as wireless router or RF transmitter module through Web UI thereof. These operations are not very convenient, and daily use thereof may be seriously influenced.

Therefore, how to conveniently control the transmitting power of network access apparatus such as wireless router has become an urgent technical problem.

### SUMMARY

In light of this, the disclosure provides a device and method for controlling transmitting power of network access apparatus, which is able to lower the wireless radiation of the network access apparatus without impacting on the network connection.

The disclosure provides a portable terminal for controlling transmitting power of network access apparatus, including at least one processor, and a memory communicably connected with the at least one processor for storing instructions executable by the at least one processor, wherein execution of the instructions by the at least one processor causes the at least one processor to:

establish a wireless network connection between the portable terminal and the network access apparatus;

obtain a strength of wireless signal sent from the network access apparatus and received by the portable terminal upon the establishment of the wireless network connection:

calculate out a minimum transmitting power of the network access apparatus which allows the portable terminal to receive wireless signal sent from the network access apparatus, according to the strength of the wireless signal; and

generate and send a power control instruction to the network access apparatus based on the minimum transmitting power, the power control instruction regulating a first transmitting power of the network access apparatus to a second transmitting power.

The disclosure also provides a network access apparatus for controlling transmitting power of network access apparatus, which includes at least one processor; and a memory communicably connected with the at least one processor for storing instructions executable by the at least one processor, wherein execution of the instructions by the at least one processor causes the at least one processor to:

send a wireless signal to a portable terminal which is connected to the network access apparatus in a wireless manner;

receive a strength of wireless signal which is received by and fed back from the portable terminal;

calculate out a minimum transmitting power of the network access apparatus which allows the portable terminal to receive wireless signal sent from the network access apparatus, according to the strength of wireless signal; and

generate a power control instruction based on the minimum transmitting power, and control a power control interface of the RF transmitter module to regulate its transmitting power from a first transmitting power to a second transmitting power.

The disclosure also provides a method for controlling transmitting power of network access apparatus, which is applicable to a portable terminal and which includes:

establishing a wireless network connection between the portable terminal and the network access apparatus;

obtaining a strength of wireless signal sent from the network access apparatus and received by the portable terminal;

calculating out a minimum transmitting power of the network access apparatus which allows the portable terminal to receive wireless signal sent from the network access apparatus, according to the strength of wireless signal; and

generating a power control instruction based on the minimum transmitting power and sending the power control instruction to the network access apparatus, the power control instruction regulating a first transmitting power of the network access apparatus to a second transmitting power.

Preferably, in the disclosure, if the wireless network connection is not established between the portable terminal and the network access apparatus, then

providing a prompt to shorten the distance between the portable terminal and the network access apparatus, until the wireless network connection is established; and

regulating the first transmitting power of the network access apparatus to the transmitting power when network access apparatus normally starts up.

Preferably, in the disclosure, the step of calculating out a minimum transmitting power of the network access apparatus which allows the portable terminal to receive wireless signal sent from the network access apparatus according to the strength of wireless signal, comprises:

calculating a distance between the portable terminal and the network access apparatus, according to the strength of wireless signal; and

calculating a minimum transmitting power of the network access apparatus which covers the distance as the minimum transmitting power of the network access apparatus which allows the portable terminal to receive wireless signal sent from the network access apparatus,

or, the step of calculating out a minimum transmitting power of the network access apparatus which allows the portable terminal to receive wireless signal sent from the network access apparatus according to the strength of wireless signal, comprises:

calculating a ratio of the received strength of wireless signal to a minimum strength of the wireless signal received by the portable terminal and sent from the network access apparatus; and

multiplying the current transmitting power of the network access apparatus by the ratio, to calculate out the minimum transmitting power of the network access apparatus which allows the portable terminal to receive wireless signal sent from the network access apparatus.

Preferably, in the disclosure, the second transmitting power is a sum of the minimum transmitting power and a first predefined gain value, and the first predefined gain value is more than or equal to a value of 0 dBM.

The disclosure also provides a method for controlling transmitting power of network access apparatus, which is applicable to the network access apparatus and which includes:

sending a wireless signal to a portable terminal which is connected to the network access apparatus in a wireless manner;

receiving a strength of wireless signal which is received by and fed back from the portable terminal;

calculating out a minimum transmitting power of the network access apparatus which allows the portable terminal to receive wireless signal sent from the network access apparatus, according to the strength of wireless signal; and

generating a power control instruction based on the minimum transmitting power, and controlling a power control interface of the RF transmitter module to regulate its transmitting power from a first transmitting power to a second transmitting power.

Preferably, in the disclosure, if the strength of wireless signal which is received by and fed back from the portable terminal is not received, then

controlling the transmitting power of the network access apparatus to be stepwise increased by a second predefined gain value, until the feedback obtaining module receives the strength of wireless signal received by and fed back from the portable terminal.

The disclosure also provides a computer readable recording medium in which a program for executing the method as set forth is recorded.

As could be seen from above, the disclosure is applicable to the portable terminal or the network access apparatus. According to the strength of wireless signal sent from the network access apparatus and received by the portable terminal, it is possible to calculate out a minimum transmitting power of the network access apparatus which allows the portable terminal to receive wireless signal sent from the network access apparatus, and then regulate the transmitting power of the network access apparatus according to the minimum transmitting power. Therefore, the disclosure can reduce the wireless radiation of the network access apparatus without impacting on the network connection. Further, operations of the disclosure are very simple without interference with daily use.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a block diagram of a device for controlling transmitting power of network access apparatus according to an embodiment of the disclosure.

FIG. 2 is a block diagram of a power calculation module according to an embodiment of the disclosure.

FIG. 3 is a block diagram of a power calculation module according to another embodiment of the disclosure.

FIG. 4 is a schematic diagram of signal transmission in a specific implementation of the disclosure.

FIG. 5 is a block diagram of a device for controlling transmitting power of network access apparatus according to another embodiment of the disclosure.

FIG. 6 is a block diagram of a power calculation module according to still another embodiment of the disclosure.

FIG. 7 is a schematic diagram of signal transmission in another specific implementation of the disclosure.

FIG. 8 is a flow chart of a method for controlling transmitting power of network access apparatus according to an embodiment of the disclosure.

FIG. 9 is a flow chart of a method for controlling transmitting power of network access apparatus according to another embodiment of the disclosure.

FIG. 10 schematically depicts a block diagram of an electronic device for executing the method according to the present disclosure.

FIG. 11 schematically depicts a storage unit for keeping or carrying a program code, which realizes the method according to the present disclosure.

### DESCRIPTION OF THE EMBODIMENTS

A family WLAN usually includes devices such as PC, smart television, portable terminal, etc, which could be connected to Internet via a network access apparatus such as a wireless router. Usually, the transmitting power of the network access apparatus such as wireless router can be regulated through Web UI of the devices such as PC, smart television, portable terminal, etc. In other words, after a transmitting power as required is evaluated, the transmitting power would be manually set on the Web UI. Then the transmitting power manually set on the Web UI is sent to the network access apparatus, such that the power range emitted from a power control interface of a RF transmitting chip in the network access apparatus could be regulated. However, in this method for regulating the transmitting power, there is a need to evaluate the desirable transmitting power by experience and then manually set the transmitting power on the Web UI. However, this method for regulating the transmitting power of network access apparatus, operations of which are very complicated, requires an operator to have some technical knowledge. Therefore, the transmitting power of the network access apparatus cannot be regulated in real time as required.

The disclosure applicable to a portable terminal or a network access apparatus can calculate out a minimum transmitting power of the network access apparatus which allows the portable terminal to receive wireless signal sent from the network access apparatus, according to the strength of the wireless signal sent from the network access apparatus and received by the portable terminal, and then regulate the transmitting power of the network access apparatus based on the minimum transmitting power. Therefore, in the disclosure the wireless radiation of the network access apparatus can be lowered without impacting on the network connection. Further, in the disclosure, the operations are very simple, and the transmitting power of the network access apparatus can be regulated in real time as required.

Hereinafter, the specific implementations of the disclosure will be further described in conjunction with the accompanying drawings.

The device for controlling the transmitting power of the network access apparatus according to the disclosure is applicable to the portable terminal. In the specific implementation, generally, the device according to the disclosure, as application software (APP), is installed in the portable terminal. The portable terminal includes a portable apparatus such as tablet, cell phone, etc, widely used in family nowadays. The portable terminal installed with the device according to the disclosure may be communicated with the network access apparatus in the family WLAN in a wireless manner, in order to regulate the power range emitted from the power control interface of the RF transmitting chip in the network access apparatus. Normally, the portable terminal includes a MCU (Micro Control Unit), an I/O module, memory, etc.

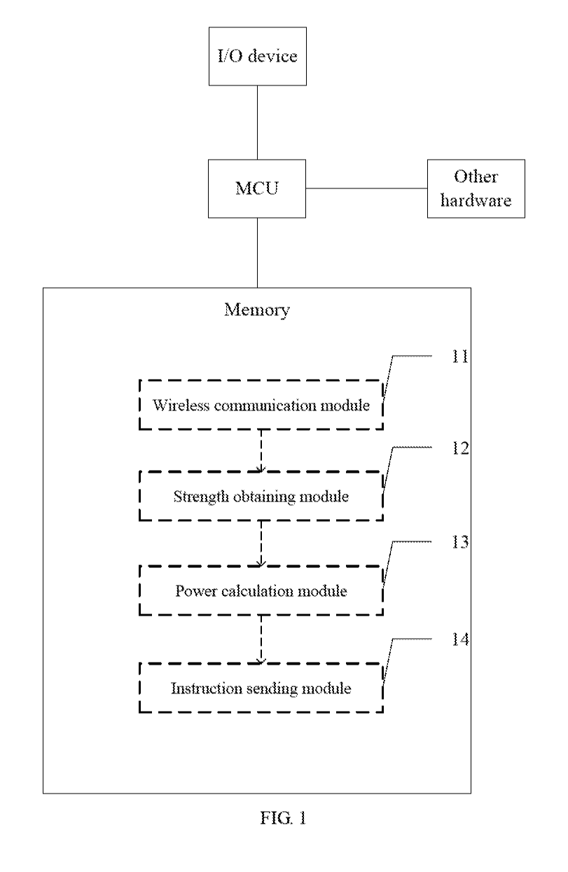

With reference to FIG. 1, the device for controlling the transmitting power of the network access apparatus may include:

a wireless communication module 11, configured to establish a wireless network connection between the portable terminal and the network access apparatus;

a strength obtaining module 12, configured to obtain a strength of wireless signal sent from the network access apparatus and received by the portable terminal upon the establishment of the wireless network connection;

a power calculation module 13, configured to calculate out a minimum transmitting power of the network access apparatus which allows the portable terminal to receive wireless signal sent from the network access apparatus, according to the strength of the wireless signal; and

an instruction sending module 14, configured to generate and send a power control instruction to the network access apparatus based on the minimum transmitting power, the power control instruction regulating a first transmitting power of the network access apparatus to a second transmitting power.

As could be seen from above, by obtaining strength of wireless signal sent from the network access apparatus and received by the portable terminal, the disclosure can calculate out a minimum transmitting power of the network access apparatus which allows the portable terminal to receive wireless signal sent from the network access apparatus, and then control the transmitting power of the network access apparatus according to the minimum transmitting power. For the network access apparatus such as the wireless router, instead of receiving the transmitting power manually set through the Web UI, the disclosure could receive the power control instruction generated based on the minimum transmitting power and sent from the portable terminal to regulate its transmitting power. According to the disclosure, it is possible to lower the transmitting power of the network access apparatus without impacting on the network connection, thereby reducing the power consumption and wireless radiation of the network access apparatus. Further, in the disclosure, the operations are very simple, and the transmitting power of the network access apparatus can be regulated in real time as required.

Additionally, in the disclosure, only a simple APP is installed in the portable terminal. For the network access apparatus such as the wireless router, the transmitting power could be regulated by receiving the power control instruction sent from the portable terminal instead of receiving the transmitting power manually set through the Web UI. Therefore, since, in the disclosure, the portable terminal could provide a convenient and flexible control by using APP without any changes in hardware, the cost thereof is inexpensive and use is very simple. In the disclosure, the network access apparatus could only necessarily receive the power control instruction sent from the portable terminal to regulate the power emitted from the power control interface of RF chip.

In a specific implementation of the disclosure, following situations may occur. In the first situation, after the transmitting power of the network access apparatus is lowered by the control of the portable terminal, the wireless communication could not be established between the portable terminal and the network access apparatus due to a new barrier brought thereto and the like. In the second situation, after the transmitting power of the network access apparatus has been lowered by the control of the previous portable terminal, when another new portable terminal joins to the family WLAN, the newly joined portable terminal could not establish a wireless communication with the network access apparatus due to a longer distance from the network access apparatus or barriers therebetween.

In the case of above first situation, in the device for controlling the transmitting power of the network access apparatus according to the disclosure, the wireless communication module 11 is further configured, if the wireless network connection is not established between the portable terminal and the network access apparatus, then to provide a prompt to shorten the distance between the portable terminal and the network access apparatus until the wireless network connection is established. In other words, if the portable terminal installed with the APP according to the disclosure could not establish the wireless network connection with the network access apparatus, the portable terminal will be requested to approach the network access apparatus until the wireless network connection can be re-established between the portable terminal and the network access apparatus. This is because the portable terminal can resend the power control instruction to the network access apparatus only when the wireless network connection is established between the portable terminal and the network access apparatus. After the wireless network connection is re-established between the portable terminal and the network access apparatus, the instruction sending module 14 is further configured to regulate the first transmitting power of the network access apparatus to the transmitting power when network access apparatus normally starts up. In such a manner, the transmitting power of the network access apparatus is increased, so that the wireless network connection can be established between the portable terminal and the network access apparatus even when the portable terminal returns to its original position. The portable terminal may re-control the transmitting power of the network access apparatus via the APP installed therein, in order to re-regulate the transmitting power of the network access apparatus in accordance with the current strength of wireless signal received by the portable terminal and sent from network access apparatus.

In the case of the second situation, the disclosure is installed both in the existing portable terminal and the newly joined portable terminal, but the newly joined portable terminal could not establish the wireless network connection with the network access apparatus. As the same to the first situation, in the device for controlling the transmitting power of the network access apparatus according to the disclosure, which is installed in the newly joined portable terminal, the wireless communication module 11 is further configured, if the wireless network connection is not established between the portable terminal and the network access apparatus, then to provide a prompt to shorten the distance between the portable terminal and the network access apparatus until the wireless network connection is established. In other words, if the newly joined portable terminal installed with the APP according to the disclosure could not establish the wireless network connection with the network access apparatus, then the newly joined portable terminal will be requested to approach the network access apparatus, until the newly joined portable terminal is allowed to establish the wireless network connection with the network access apparatus. After the wireless network connection is established between the newly joined portable terminal and the network access apparatus, the instruction sending module 14 is further configured to regulate the first transmitting power of the network access apparatus to the transmitting power when network access apparatus normally starts up. In such a manner, the transmitting power of the network access apparatus is increased, so that the wireless network connection can be established between the portable terminal and the network access apparatus even when the newly joined portable terminal returns to its original position. The newly joined portable terminal may re-control the transmitting power of the network access apparatus via the APP installed therein, in order to down regulate the transmitting power of the network access apparatus again in accordance with the current strength of wireless signal received by the newly joined portable terminal and sent from network access apparatus.

The wireless network connection established between the portable terminal and the network access apparatus in above two situations includes not only the wireless network connection via the family WLAN in the disclosure but also a wireless network connection via a public network. In other words, as long as there is a wireless network signal between the portable terminal and the network access apparatus, it will fall within the wireless network connection established between the portable terminal and the network access apparatus according to the disclosure.

Additionally, in order to control the transmitting power of the network access apparatus based on the position of the portable terminal at any time, in the device for controlling the transmitting power of the network access apparatus according to the disclosure, the strength obtaining module 12 may be configured to circularly collect the strength of wireless signal sent from the network access apparatus and received by the portable terminal following a predefined period. The power calculation module 13 may calculate out the minimum transmitting power of the network access apparatus which allows the portable terminal to receive wireless signal sent from the network access apparatus according to the circularly collected strength of wireless signal. The instruction sending module 14 can circularly send the power control instruction to the network access apparatus following a predefined period to control the transmitting power of the network access apparatus. In such a manner, if the portable terminal is getting close to the network access apparatus, the transmitting power of the network access apparatus can be gradually down regulated.

In a specific implementation of the disclosure, for example, a plurality of portable terminals join to the family local area network, and the down-regulation of transmitting power of the network access apparatus by one of the portable terminals results in that the other portable terminals could not establish a wireless network connection with the network access apparatus. At this point, as stated in the second situation, the portable terminals that cannot establish the wireless network connection with the network access apparatus would be provided with a prompt to shorten the distance between the portable terminal and the network access apparatus, until the wireless network connection is established. Preferably, when a plurality of portable terminals join to the family local area network in the disclosure, the plurality of portable terminals could be prompted that one of the portable terminals has regulated the transmitting power of the network access apparatus and could choose whether to shut down the APP as necessary.

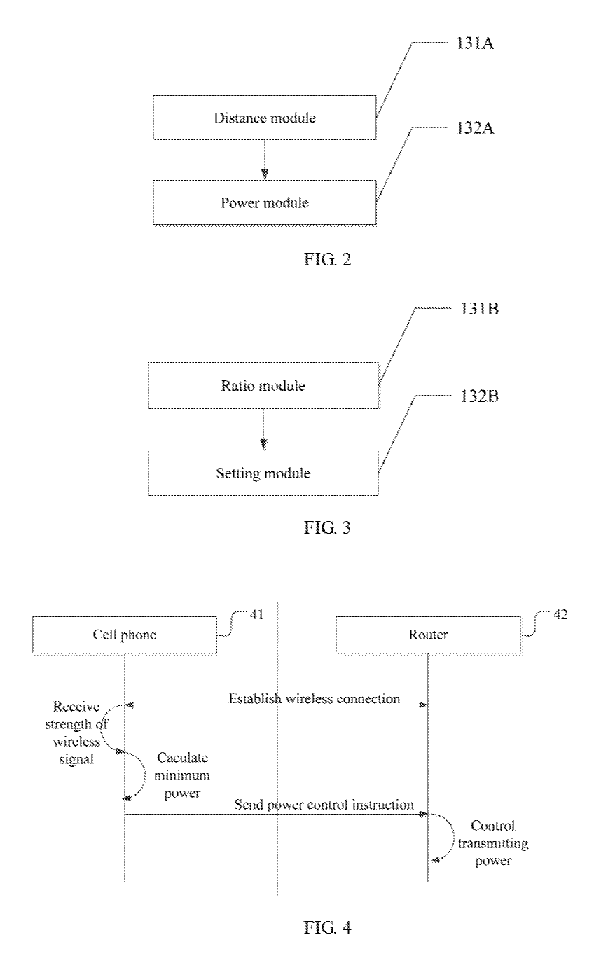

In particular, in an embodiment of the disclosure, with reference to FIG. 2, the power calculation module 13 may include:

a distance module 131A, configured to calculate a distance between the portable terminal and the network access apparatus according to the strength of wireless signal; and

a power module 132A, configured to calculate a minimum transmitting power of the network access apparatus which covers the distance as the minimum transmitting power of the network access apparatus which allows the portable terminal to receive wireless signal sent from the network access apparatus.

It should be noted, in the disclosure, the distance between the portable terminal and the network access apparatus obtained according to the strength of the wireless signal does not take account of barriers between the portable terminal and the network access apparatus. In principle, the stronger the wireless signal is, the less distance between the portable terminal and the network access apparatus, or vice versa. Therefore, the distance therebetween calculated out by the strength of the wireless signal in this embodiment is only used as reference feeding back the signal strength rather than representing an actual physical distance therebetween.

In this embodiment, the distance between the portable terminal and the network access apparatus is calculated out according to the strength of the wireless signal. This means that when the minimum transmitting power of the network access apparatus which covers the distance is used as the transmitting power, the portable terminal is allowed to receive the wireless signal sent from the network access apparatus.

In particular, in another embodiment of the disclosure, with reference to FIG. 3, the power calculation module 13 may include:

a ratio module 131B, configured to calculate a ratio of the received strength of wireless signal to a minimum strength of the wireless signal received by the portable terminal and sent from the network access apparatus; and

a setting module 132B, configured to multiply the current transmitting power of the network access apparatus by the ratio, to calculate out the minimum transmitting power of the network access apparatus which allows the portable terminal to receive wireless signal sent from the network access apparatus.

In this embodiment, the transmitting power can be regulated based on the ratio between the strength of wireless signal and the transmitting power. Usually, the stronger wireless signal is accepted by the portable terminal, the greater transmitting power of the network access apparatus. When the portable terminal is able to receive the wireless signal sent from the network access apparatus but the received strength of wireless signal is minimum, the transmitting power of the network access apparatus is minimum at this point while the wireless network connection between the portable terminal and the network access apparatus can be ensured.

However, when the transmitting power of the network access apparatus is regulated to the minimum transmitting power, if the portable terminal is moved a bit away from the network access apparatus or a person passes through between the portable terminal and the network access apparatus, the wireless network connection between the portable terminal and the network access apparatus may easily trend to instability. Therefore, the transmitting power of the network access apparatus is normally regulated to the second transmitting power. The second transmitting power is a sum of the minimum transmitting power and a first predefined gain value. The first predefined gain value is more than or equal to a value of 0 dBM. The first predefined gain value is selected according to requirement and experience by those skilled in the art.

The second transmitting power is the stun of the minimum transmitting power and the first predefined gain value. Generally, the first predefined gain value is very small. Generally, the second transmitting power is less than the first transmitting power. That is, in the disclosure, the transmitting power of the network access apparatus is normally down regulated by the portable terminal, to such a degree that it is lower than the previous transmitting power of the network access apparatus but slightly higher than the minimum transmitting power which allows for the wireless connection established between the portable terminal and the network access apparatus. However, in some circumstances, a situation where the second transmitting power is higher than the first transmitting power is not excluded. For example, although the portable terminal can receive the wireless signal sent from the network access apparatus, the strength of wireless signal is very low, which represents the wireless network connection is established between the portable terminal and the network access apparatus but unstable. At this point, it is necessary to up regulate the transmitting power of the wireless network connection apparatus, so that in the meanwhile, the sum of the minimum transmitting power and the first predefined gain value is more than the first transmitting power, and the second transmitting power is also more than the first transmitting power.

In order to further explain the implementations of the disclosure, a specific implementation will be provided for the illustrative purpose of the disclosure.

With reference to FIG. 4, a cell phone 41 and a router 42 are included in a family WLAN. The cell phone 41 is installed with an APP according to the disclosure to control transmitting power of the router 42. A wireless network connection is established between the cell phone 41 and the router 42. The cell phone 41 may obtain strength of received wireless signal sent from the router 42. The cell phone 41 may calculate out a minimum transmitting power of the router 42 which allows the cell phone 41 to receive wireless signal sent from the router 2 by the strength of wireless signal. The cell phone 41 may generate and send a power control instruction to the router 42 based on the minimum transmitting power. The router 42 may regulate the transmitting power thereof from a first transmitting power to a second transmitting power according to the power control instruction.

The device for controlling transmitting power of network access apparatus according to the disclosure is applicable to the network access apparatus. In the specific implementation, when the network access apparatus is a HiWiFi apparatus, the device according to the disclosure may be installed in the HiWiFi apparatus as an APP. When the network access apparatus is a common router, the device according to the disclosure may also be implemented by hardware. The network access apparatus in the disclosure can be communicated with the portable terminal in the family WLAN in a wireless manner, in order to regulate the power range emitted from the power control interface of the RF transmitting chip in the network access apparatus.

With reference to FIG. 5, the device 5 for controlling transmitting power of network access apparatus in the disclosure may include:

a RF transmitter module 51, configured to send a wireless signal to a portable terminal which is connected to the network access apparatus in a wireless manner;

a feedback obtaining module 52, configured to receive a strength of wireless signal which is received by and fed back from the portable terminal;

a power calculation module 53, configured to calculate out a minimum transmitting power of the network access apparatus which allows the portable terminal to receive wireless signal sent from the network access apparatus, according to the strength of wireless signal; and

a power control module 54, configured to generate a power control instruction based on the minimum transmitting power, and control a power control interface of the RF transmitter module to regulate its transmitting power from a first transmitting power to a second transmitting power.

As could be seen from above, by obtaining the strength of wireless signal sent from the network access apparatus and received by the portable terminal, the disclosure can calculate out a minimum transmitting power of the network access apparatus which allows the portable terminal to receive wireless signal sent from the network access apparatus, and then control the transmitting power of the network access apparatus according to the minimum transmitting power. For the network access apparatus such as the wireless router, instead of receiving the transmitting power manually set through the Web UI, the disclosure could receive the strength of wireless signal sent from the portable terminal to regulate its transmitting power. According to the disclosure, it is possible to lower the transmitting power of the network access apparatus without impacting on the network connection, thereby reducing the power consumption and wireless radiation of the network access apparatus. Further, in the disclosure, the operations are very simple, and the transmitting power of the network access apparatus can be regulated in real time as required.

In a specific implementation of the disclosure, following situations may occur. In the first situation, after the transmitting power of the network access apparatus is lowered, the wireless communication could not be established between the portable terminal and the network access apparatus due to a new barrier brought thereto and the like. In the second situation, after the transmitting power of the network access apparatus has been lowered according to the previous signal strength fed back from the portable terminal, when another new portable terminal joins to the family WLAN, the newly joined portable terminal could not establish a wireless communication with the network access apparatus due to a longer distance from the network access apparatus or barriers therebetween.

In the case of above first and second situations, in the device for controlling the transmitting power of the network access apparatus according to the disclosure, if the feedback obtaining module 52 fails to receive the strength of wireless signal which is received by and fed back from the portable terminal, that is, the portable terminal could not establish the wireless network connection with the network access apparatus, then the power control module 54 may be further configured to control the transmitting power of the network access apparatus to be stepwise increased by a second predefined gain value, until the feedback obtaining module can receive the strength of wireless signal received by and fed back from the portable terminal. The transmitting power of the network access apparatus is stepwise increased by a second predefined gain value, such that the transmitting power of the network access apparatus is stepwise increased until the wireless network connection between the network access apparatus and the portable terminal is restored. The second predefined gain value is selected according to requirement and experience by those skilled in the art.

The wireless network connection established between the portable terminal and the network access apparatus in above two situations includes not only the wireless network connection via the family WLAN in the disclosure but also a wireless network connection via a public network. In other words, as long as there is a wireless network signal between the portable terminal and the network access apparatus, it will fall within the wireless network connection established between the portable terminal and the network access apparatus according to the disclosure.

Additionally, in order to control the transmitting power of the network access apparatus based on the feedback signal strength of portable terminal at any time, the portable terminal in the disclosure can be configured to circularly send the strength of wireless signal received by the portable terminal and sent from the network access apparatus to the network access apparatus following a predefined period. The feedback obtaining module 52 can receive the strength of wireless signal which is received by and fed back from the portable terminal. The power calculation module 53 can calculate out the minimum transmitting power of the network access apparatus which allows the portable terminal to receive wireless signal sent from the network access apparatus according to the strength of wireless signal. The power control module 54 can generate a power control instruction based on the minimum transmitting power following the predefined periodic circulation, and control the power control interface of the RF transmitter module to regulate its transmitting power from the first transmitting power to the second transmitting power.

In the case that the network access apparatus in the disclosure is a network access apparatus such as HiWiFi apparatus on which software can be operated, the power calculation module 53 in this embodiment can be implemented by the same software program as the power calculation module 13. Thus the implementation thereof will be omitted herein.

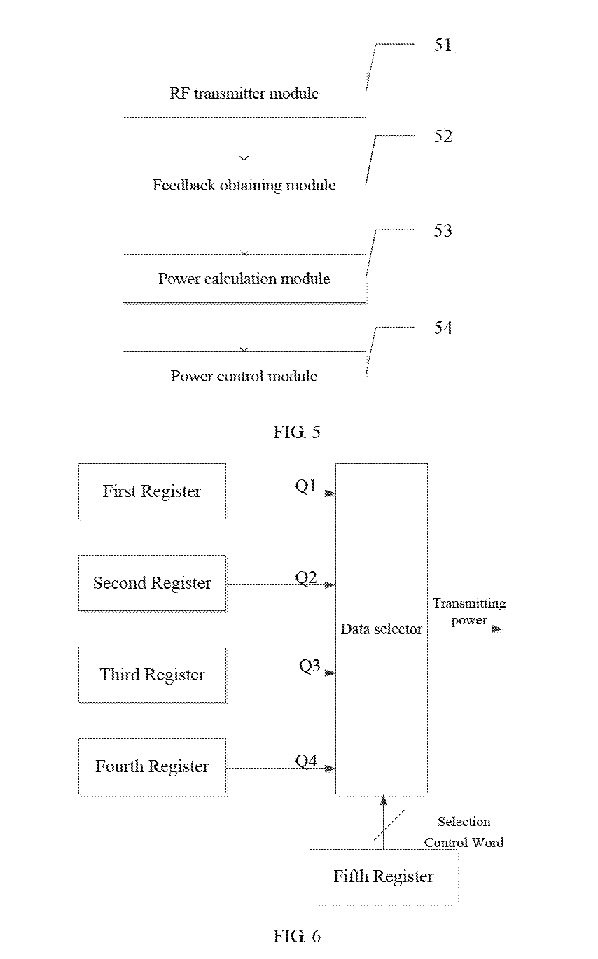

In the case that the network access apparatus in the disclosure is a common router, the power calculation module 53 in this embodiment can be implemented by a hardware register and a data selector. In particular, with reference to FIG. 6, a plurality of registers can be used to store multiple levels of transmitting power and signal strength, the signal strength can be converted into selection control words of the data selector, and the data selector can select the transmitting power according to the signal strength range. The corresponding relation between the signal strength and the transmitting power will be shown in detail in Table 1.

TABLE 1

| Signal Strength | Selection Control Word | Transmitting Power | Output |
|---|---|---|---|
| 5-10 dBm | 0, 0 | 20 dBm | Q1 |
| 10-20 dBm | 0, 1 | 30 dBm | Q2 |
| 20-30 dBm | 1, 0 | 40 dBm | Q3 |
| 30-40 dBm | 1, 1 | 50 dBm | Q4 |

In order to further explain the implementations of the disclosure, a specific implementation will be provided for the illustrative purpose of the disclosure.

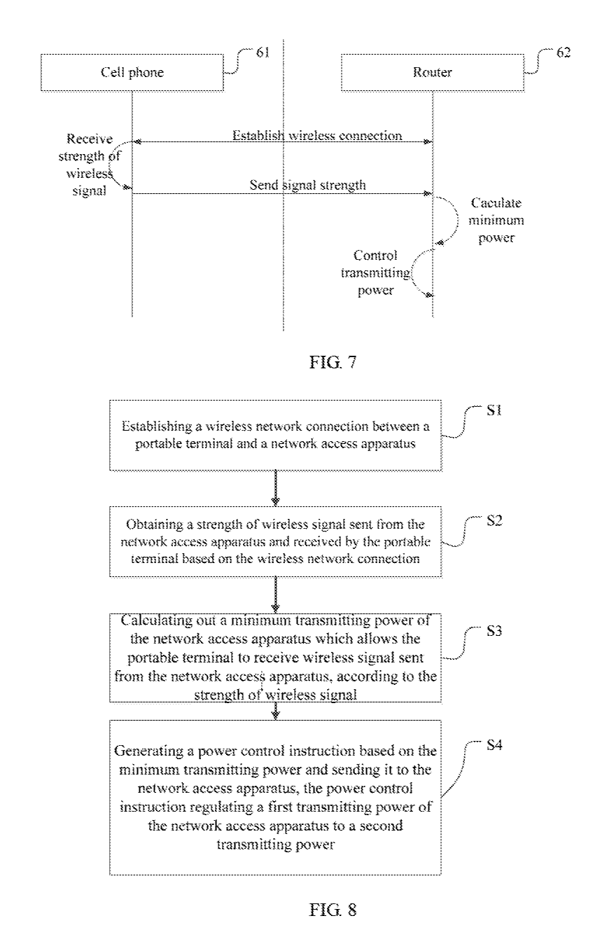

With reference to FIG. 7, a cell phone 71 and a router 72 are included in a family WLAN. The cell phone 71 may send a strength of received wireless signal sent from the router 72 to the router 72, in order to control transmitting power of the router 72. A wireless network connection is established between the cell phone 71 and the router 72. The cell phone 71 may obtain strength of received wireless signal sent from the router 72. The cell phone 71 may feed the strength of wireless signal back to the router 72, and the router 72 may calculate a minimum transmitting power of the router 72 which allows the cell phone 71 to receive wireless signal sent from the router 2. The router 72 may regulate the transmitting power thereof from a first transmitting power to a second transmitting power according to the minimum transmitting power.

Correspondingly to above device, the disclosure also provides a method for controlling transmitting power of network access apparatus, which is applicable to a portable terminal. With reference to FIG. 8, the method may include steps of:

S1, establishing a wireless network connection between a portable terminal and a network access apparatus;

S2, obtaining a strength of wireless signal sent from the network access apparatus and received by the portable terminal based on the wireless network connection;

S3, calculating out a minimum transmitting power of the network access apparatus which allows the portable terminal to receive wireless signal sent from the network access apparatus, according to the strength of wireless signal; and

S4, generating a power control instruction based on the minimum transmitting power and sending it to the network access apparatus, the power control instruction regulating a first transmitting power of the network access apparatus to a second transmitting power.

As could be seen from above, for the network access apparatus such as the wireless router, instead of receiving the transmitting power manually set through the Web UI, the disclosure could receive the power control instruction generated based on the minimum transmitting power and sent from the portable terminal to regulate its transmitting power. According to the disclosure, it is possible to lower the transmitting power of the network access apparatus without impacting on the network connection, thereby reducing the power consumption and wireless radiation of the network access apparatus. Further, in the disclosure, the operations are very simple, and the transmitting power of the network access apparatus can be regulated in real time as required.

Additionally, in the disclosure, only a simple APP is installed in the portable terminal. For the network access apparatus such as the wireless router, the transmitting power could be regulated by receiving the power control instruction sent from the portable terminal instead of receiving the transmitting power manually set through the Web UI.

In a specific implementation of the disclosure, following situations may occur. In the first situation, after the transmitting power of the network access apparatus is lowered by the control of the portable terminal, the wireless communication could not be established between the portable terminal and the network access apparatus due to a new barrier brought thereto and the like. In the second situation, after the transmitting power of the network access apparatus has been lowered by the control of the previous portable terminal, when another new portable terminal joins to the family WLAN, the newly joined portable terminal could not establish a wireless communication with the network access apparatus due to a longer distance from the network access apparatus or barriers therebetween.

In the case of above first situation, if the wireless network connection is not established between the portable terminal and the network access apparatus, then the disclosure may provide a prompt to shorten the distance between the portable terminal and the network access apparatus, until the wireless network connection is established. In other words, if the portable terminal installed with the APP according to the disclosure could not establish the wireless network connection with the network access apparatus, the portable terminal will be requested to approach the network access apparatus until the wireless network connection can be re-established between the portable terminal and the network access apparatus. After the wireless network connection is re-established between the portable terminal and the network access apparatus, the network access apparatus may be controlled to be regulated from the first transmitting power to the transmitting power when network access apparatus normally starts up. In such a manner, the transmitting power of the network access apparatus is increased, so that the wireless network connection can be established between the portable terminal and the network access apparatus even when the portable terminal returns to its original position. The portable terminal may re-control the transmitting power of the network access apparatus via the APP installed therein, in order to down regulate the transmitting power of the network access apparatus again in accordance with the current strength of wireless signal received by the portable terminal and sent from network access apparatus.

In the case of the second situation, the disclosure is installed both in the existing portable terminal and the newly joined portable terminal, but the newly joined portable terminal could not establish the wireless network connection with the network access apparatus. As the same to the first situation, if the wireless network connection is not established between the portable terminal and the network access apparatus, then the newly joined portable terminal may provide a prompt to shorten the distance between the portable terminal and the network access apparatus, until the wireless network connection is established. In other words, if the newly joined portable terminal installed with the APP according to the disclosure could not establish the wireless network connection with the network access apparatus, then the newly joined portable terminal will be requested to approach the network access apparatus, until the newly joined portable terminal is allowed to establish the wireless network connection with the network access apparatus. After the wireless network connection is established between the newly joined portable terminal and the network access apparatus, the first transmitting power of the network access apparatus is regulated to the transmitting power when network access apparatus normally starts up. In such a manner, the transmitting power of the network access apparatus is increased, so that the wireless network connection can be established between the portable terminal and the network access apparatus even when the newly joined portable terminal returns to its original position. The newly joined portable terminal may re-control the transmitting power of the network access apparatus via the APP installed therein, in order to down regulate the transmitting power of the network access apparatus again in accordance with the current strength of wireless signal received by the newly joined portable terminal and sent from network access apparatus.

In particular, in an embodiment of the disclosure, Step S3 in the disclosure may include:

calculating a distance between the portable terminal and the network access apparatus, according to the strength of wireless signal; and

calculating a minimum transmitting power of the network access apparatus which covers the distance as the minimum transmitting power of the network access apparatus which allows the portable terminal to receive wireless signal sent from the network access apparatus.

In this embodiment, the distance between the portable terminal and the network access apparatus is calculated out according to the strength of wireless signal. This means that when the minimum transmitting power of the network access apparatus which covers the distance is used as the transmitting power, the portable terminal is allowed to receive the wireless signal sent from the network access apparatus.

In particular, in another embodiment of the disclosure, Step S3 in the disclosure may include:

calculating a ratio of the received strength of wireless signal to a minimum strength of the wireless signal received by the portable terminal and sent from the network access apparatus; and

multiplying the current transmitting power of the network access apparatus by the ratio, to calculate out the minimum transmitting power of the network access apparatus which allows the portable terminal to receive wireless signal sent from the network access apparatus.

In this embodiment, the transmitting power can be regulated based on the ratio between the strength of wireless signal and the transmitting power. Usually, the stronger wireless signal is accepted by the portable terminal, the greater transmitting power of the network access apparatus. When the portable terminal is able to receive the wireless signal sent from the network access apparatus but the received strength of wireless signal is minimum, the transmitting power of the network access apparatus is minimum at this point while the wireless network connection between the portable terminal and the network access apparatus can be ensured.

In the disclosure, the second transmitting power is a sum of the minimum transmitting power and a first predefined gain value. The first predefined gain value is more than or equal to a value of 0 dBM. The first predefined gain value is selected according to requirement and experience by those skilled in the art.

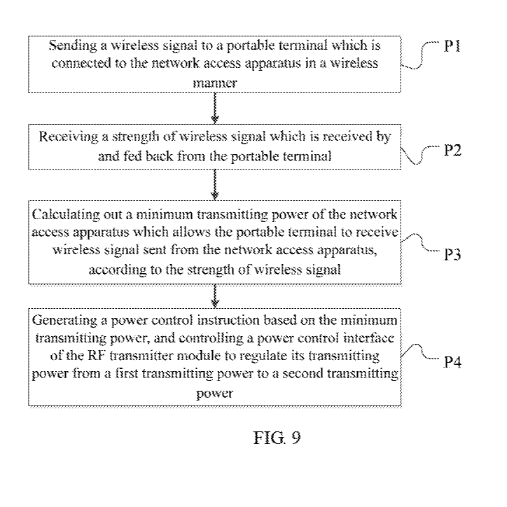

Correspondingly to above device, the disclosure also provides a method for controlling transmitting power of network access apparatus, which is applicable to the network access apparatus. With reference to FIG. 9, the method may include steps of:

P1, sending a wireless signal to a portable terminal which is connected to the network access apparatus in a wireless manner:

P2, receiving a strength of wireless signal which is received by and fed back from the portable terminal;

P3, calculating out a minimum transmitting power of the network access apparatus which allows the portable terminal to receive wireless signal sent from the network access apparatus, according to the strength of wireless signal; and

P4, generating a power control instruction based on the minimum transmitting power, and controlling a power control interface of the RF transmitter module to regulate its transmitting power from a first transmitting power to a second transmitting power.

As could be seen from above, by obtaining the strength of wireless signal sent from the network access apparatus and received by the portable terminal, the disclosure can calculate out a minimum transmitting power of the network access apparatus which allows the portable terminal to receive wireless signal sent from the network access apparatus, and then control the transmitting power of the network access apparatus according to the minimum transmitting power. For the network access apparatus such as the wireless router, instead of receiving the transmitting power manually set through the Web UI, the disclosure could receive the strength of wireless signal sent from the portable terminal to regulate its transmitting power. According to the disclosure, it is possible to lower the transmitting power of the network access apparatus without impacting on the network connection, thereby reducing the power consumption and wireless radiation of the network access apparatus. Further, in the disclosure, the operations are very simple, and the transmitting power of the network access apparatus can be regulated in real time as required.

In a specific implementation of the disclosure, following situations may occur. In the first situation, after the transmitting power of the network access apparatus is lowered, the wireless communication could not be established between the portable terminal and the network access apparatus due to a new barrier brought thereto and the like. In the second situation, after the transmitting power of the network access apparatus has been lowered according to the previous signal strength fed back from the portable terminal, when another new portable terminal joins to the family WLAN, the newly joined portable terminal could not establish a wireless communication with the network access apparatus due to a longer distance from the network access apparatus or barriers therebetween.

In the case of above first and second situations, in the device for controlling the transmitting power of the network access apparatus according to the disclosure, if the feedback obtaining module 52 fails to receive the strength of wireless signal which is received by and fed back from the portable terminal, that is, the portable terminal could not establish the wireless network connection with the network access apparatus, then the power control module 54 may be further configured to control the transmitting power of the network access apparatus to be stepwise increased by a second predefined gain value, until the feedback obtaining module can receive the strength of wireless signal received by and fed back from the portable terminal. The transmitting power of the network access apparatus is stepwise increased by a second predefined gain value, such that the transmitting power of the network access apparatus is stepwise increased until the wireless network connection between the network access apparatus and the portable terminal is restored. The second predefined gain value is selected according to requirement and experience by those skilled in the art.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

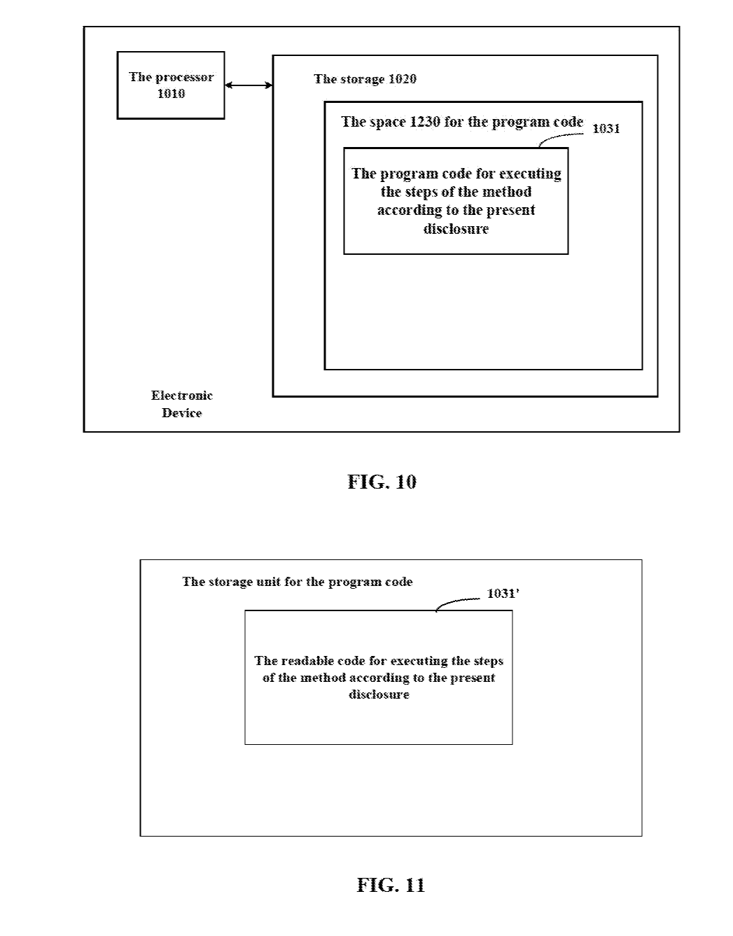

For example, FIG. 10 illustrates a block diagram of an electronic device for executing the method according the disclosure, such as the portable terminal or the network access apparatus. Traditionally, the electronic device includes a processor 1010 and a computer program product or a computer readable medium in form of a memory 1020. The memory 1020 could be electronic memories such as flash memory, EEPROM (Electrically Erasable Programmable Read-Only Memory), EPROM, hard disk or ROM. The memory 1020 has a memory space 1030 for executing program codes 1031 of any steps in the above methods. For example, the memory space 1030 for program codes may include respective program codes 1031 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 11. The memory cells may be provided with memory sections, memory spaces, etc., similar to the memory 1020 of the server as shown in FIG. 10. The program codes may be compressed for example in an appropriate form. Usually, the memory cell includes computer readable codes 1031′ which can be read for example by processors 1010. When these codes are operated on the server, the server may execute respective steps in the method as described above.

The disclosure also provides a computer readable recording medium in which a program for executing the method as set forth is recorded.

It would be understood by an ordinary skilled in the art, all or some of steps in the method embodiments as described above can be implemented by means of hardware corresponding to program instructions. The aforesaid program can be stored in computer readable storage medium. The execution of the program includes the execution of the steps in the method embodiments as described above. The aforesaid storage medium may include ROM, RAM, magnetic disc, optical disc and any other medium which is able to store the program codes.

In the end, it should be explained that aforesaid embodiments are provided for the purpose of illustrating not limiting the technical schemes of the disclosure. Although the disclosure has been described in detail with reference to the embodiments, it should be understood by those skilled in the art that modifications or equivalent substitutions can be made to the technical schemes or some of technical features therein as disclosed in the embodiments; the modifications or substitutions will not bring the essence of the respective technical schemes to depart from the scope of the technical schemes of the inventive embodiments.

What is claimed is:

1. A portable terminal for controlling transmitting power of network access apparatus, comprising:
at least one processor; and
a memory communicably connected with the at least one processor for storing instructions executable by the at least one processor, wherein execution of the instructions by the at least one processor causes the at least one processor to:
establish a wireless network connection between the portable terminal and the network access apparatus:
obtain a strength of wireless signal sent from the network access apparatus and received by the portable terminal upon the establishment of the wireless network connection;
calculate out a minimum transmitting power of the network access apparatus which allows the portable terminal to receive wireless signal sent from the network access apparatus, according to the strength of the wireless signal; and
generate and send a power control instruction to the network access apparatus based on the minimum transmitting power, the power control instruction regulating a first transmitting power of the network access apparatus to a second transmitting power.

2. The portable terminal according to claim 1, wherein execution of the instructions by the at least one processor causes the at least one processor to further:
if the wireless network connection is not established between the portable terminal and the network access apparatus, provide a prompt to shorten the distance between the portable terminal and the network access apparatus until the wireless network connection is established; and
regulate the transmitting power of the network access apparatus to the transmitting power when network access apparatus normally starts up.

3. The portable terminal according to claim 1, wherein calculating out a minimum transmitting power of the network access apparatus which allows the portable terminal to receive wireless signal sent from the network access apparatus according to the strength of wireless signal, comprises:
calculate a distance between the portable terminal and the network access apparatus according to the strength of wireless signal; and
calculate a minimum transmitting power of the network access apparatus which covers the distance as the minimum transmitting power of the network access apparatus which allows the portable terminal to receive wireless signal sent from the network access apparatus,
or, calculate out a minimum transmitting power of the network access apparatus which allows the portable terminal to receive wireless signal sent from the network access apparatus according to the strength of wireless signal, comprises:
calculate a ratio of the received strength of wireless signal to a minimum strength of the wireless signal received by the portable terminal and sent from the network access apparatus; and
multiply the current transmitting power of the network access apparatus by the ratio, to calculate out the minimum transmitting power of the network access apparatus which allows the portable terminal to receive wireless signal sent from the network access apparatus.

4. The portable terminal according to claim 1, wherein the second transmitting power is a sum of the minimum transmitting power and a first predefined gain value, and the first predefined gain value is more than or equal to a value of 0 dBM.

5. A network access apparatus for controlling transmitting power of network access apparatus, comprising:
at least one processor, and
a memory communicably connected with the at least one processor for storing instructions executable by the at least one processor, wherein execution of the instructions by the at least one processor causes the at least one processor to:
send a wireless signal to a portable terminal which is connected to the network access apparatus in a wireless manner,
receive a strength of wireless signal which is received by and fed back from the portable terminal;
calculate out a minimum transmitting power of the network access apparatus which allows the portable terminal to receive wireless signal sent from the network access apparatus, according to the strength of wireless signal; and
generate a power control instruction based on the minimum transmitting power, and control a power control interface of the RF transmitter module to regulate its transmitting power from a first transmitting power to a second transmitting power.

6. The network access apparatus according to claim 5, wherein execution of the instructions by the at least one processor causes the at least one processor to further:
if the strength of wireless signal which is received by and fed back from the portable terminal is not received, control the transmitting power of the network access apparatus to be stepwise increased by a second predefined gain value, until the feedback obtaining module receives the strength of wireless signal received by and fed back from the portable terminal.

7. A method for controlling transmitting power of network access apparatus, which is applicable to a portable terminal, wherein the method comprises:
establishing a wireless network connection between the portable terminal and the network access apparatus;
obtaining a strength of wireless signal sent from the network access apparatus and received by the portable terminal;
calculating out a minimum transmitting power of the network access apparatus which allows the portable terminal to receive wireless signal sent from the network access apparatus, according to the strength of wireless signal; and
generating a power control instruction based on the minimum transmitting power and sending the power control instruction to the network access apparatus, the power control instruction regulating a first transmitting power of the network access apparatus to a second transmitting power.

8. The method according to claim 7, wherein
if the wireless network connection is not established between the portable terminal and the network access apparatus, then providing a prompt to shorten the distance between the portable terminal and the network access apparatus, until the wireless network connection is established; and
regulating the first transmitting power of the network access apparatus to the transmitting power when network access apparatus normally starts up.

9. The method according to claim 7, wherein the step of calculating out a minimum transmitting power of the network access apparatus which allows the portable terminal to receive wireless signal sent from the network access apparatus according to the strength of wireless signal, comprises:
calculating a distance between the portable terminal and the network access apparatus, according to the strength of wireless signal; and
calculating a minimum transmitting power of the network access apparatus which covers the distance as the minimum transmitting power of the network access apparatus which allows the portable terminal to receive wireless signal sent from the network access apparatus,
or, the step of calculating out a minimum transmitting power of the network access apparatus which allows the portable terminal to receive wireless signal sent from the network access apparatus according to the strength of wireless signal, comprises:
calculating a ratio of the received strength of wireless signal to a minimum strength of the wireless signal received by the portable terminal and sent from the network access apparatus; and
multiplying the current transmitting power of the network access apparatus by the ratio, to calculate out the minimum transmitting power of the network access apparatus which allows the portable terminal to receive wireless signal sent from the network access apparatus.

10. The method according to claim 9, wherein the second transmitting power is a sum of the minimum transmitting power and a first predefined gain value, and the first predefined gain value is more than or equal to a value of 0 dBM.

11. A method for controlling transmitting power of network access apparatus, which is applicable to the network access apparatus, wherein the method comprises:
sending a wireless signal to a portable terminal which is connected to the network access apparatus in a wireless manner;
receiving a strength of wireless signal which is received by and fed back from the portable terminal;
calculating out a minimum transmitting power of the network access apparatus which allows the portable terminal to receive wireless signal sent from the network access apparatus, according to the strength of wireless signal; and
generating a power control instruction based on the minimum transmitting power, and controlling a power control interface of the RF transmitter module to regulate its transmitting power from a first transmitting power to a second transmitting power.

12. The method according to claim 11, wherein
if the strength of wireless signal which is received by and fed back from the portable terminal is not received, then
controlling the transmitting power of the network access apparatus to be stepwise increased by a second predefined gain value, until the feedback obtaining module receives the strength of wireless signal received by and fed back from the portable terminal.
